(19) United States
(12) Patent Application Publication
(10) Pub. No.: US 2024/0256746 A1
(43) Pub. Date: Aug. 1, 2024

(54) SCHEDULING METHOD AND SYSTEM FOR OPERATION OF RESERVOIRS TO RECHARGE FRESHWATER FOR REPELLING SALTWATER INTRUSION UNDER CHANGING CONDITIONS

(71) Applicant: Hydrology Bureau of Yangtze River Water Resources Commission, Wuhan (CN)

(72) Inventors: Baofei FENG, Wuhan (CN); Yubin CHEN, Wuhan (CN); Yurong LI, Wuhan (CN); Ming ZENG, Wuhan (CN); Xiao ZHANG, Wuhan (CN); Yuni XU, Wuhan (CN); Wenjing NIU, Wuhan (CN); Yanfei YANG, Wuhan (CN); Yifei TIAN, Wuhan (CN); Tao ZHANG, Wuhan (CN); Yinshan XU, Wuhan (CN); Hui QIU, Wuhan (CN); Jing ZHANG, Wuhan (CN); Fang CHEN, Wuhan (CN); Wenhui XING, Wuhan (CN)

(21) Appl. No.: 18/630,527

(22) Filed: Apr. 9, 2024

(30) Foreign Application Priority Data
Sep. 27, 2023 (CN) 202311260822.9

(51) Int. Cl. G06F 30/28

(52) U.S. Cl. CPC G06F 30/28

(57) ABSTRACT

A scheduling method and system for the operation of reservoirs to recharge freshwater for repelling saltwater intrusion under changing conditions. Research data of a research area is collected, the research area is generalized, and the river network topology of the area is constructed; the research data acquire the seawater flow data of each station in the research area for N time periods, analyze the correlation between the flow of a predetermined station and the saltwater intrusion and build a seawater flow spatial-temporal evolution model; rainfall data and freshwater runoff of each station are acquired to analyze the variation trends of freshwater flow and hydrological regime of each station and a first ending point and build a freshwater flow spatial-temporal evolution model; and a scheduling model for recharging freshwater for repelling saltwater intrusion is built for simulation, a scheduling method is provided, and a scheduling scheme set is formed.

### TECHNICAL FIELD

The present invention relates to a reservoir scheduling technology, in particular to a reservoir scheduling method for resisting and preventing salty tides under changing conditions.

### BACKGROUND

Coastal areas, especially delta areas, are generally densely populated and economically developed areas. With the economic development and the rapid increase in population, water in delta areas is becoming increasingly scarce. During the dry seasons every year, estuaries are subjected to saltwater intrusion of the ocean, which seriously threatens the water consumption of the delta areas, causes various water safety problems of production and life, and seriously restricts development and utilization of water resources and economic development of the Yangtze Estuary.

To solve the above problems in the prior art, the prior art mainly adopts water transfer measures to recharge freshwater for repelling saltwater intrusion. However, the development and scheduling of basin water resources have affected and continue to affect the situation of water resources and the ecological environment. At the same time, the influence of water resources scheduling on the situation of saltwater intrusion at estuaries has become a widely concerned issue.

Therefore, in-depth research and innovation are required.

### SUMMARY

The purpose of the present invention is: to provide a scheduling method for the operation of reservoirs to recharge freshwater for repelling saltwater intrusion under changing conditions in one aspect to solve the above problems in the prior art, and to provide a system for implementing the above method in the other aspect.

Technical solution: a scheduling method for the operation of reservoirs to recharge freshwater for repelling saltwater intrusion under changing conditions is provided, comprising the following steps:
Step S1: collecting research data of a research area, generalizing the research area, and constructing the river network topology of the area, wherein the river network topology at least includes a first starting point and a first ending point, the first starting point is the starting point of freshwater flow, and the first ending point is the ending point of freshwater flow into the sea and the starting point of seawater intrusion flow;
Step S2: reading the research data to acquire the seawater flow data of each station in the research area for N time periods, analyze the correlation between the flow of a predetermined station and the saltwater intrusion and build a seawater flow spatial-temporal evolution model for each time period, wherein N is a positive integer;
Step S3: for each time period, acquiring rainfall data and freshwater runoff of each station in the research area to analyze the variation trends of freshwater flow and hydrological regime of each station and the first ending point and build a freshwater flow spatial-temporal evolution model;
Step S4: building a scheduling model for recharging freshwater for repelling saltwater intrusion to acquire the current hydrometeorological data and the predicted future hydrometeorological data of the research area, simulating the effect of recharging freshwater for repelling saltwater intrusion of the research area through the seawater flow spatial-temporal evolution model and the freshwater flow spatial-temporal evolution model, providing a scheduling method, and forming a scheduling scheme set.

According to one aspect of the present application, the step S1 further comprises:
Step S11: defining the scope of the research area, and according to research purposes and characteristics of the area, reading the research data and performing preprocessing and format conversion;
Step S12: building a GIS model, and selecting data contents and data types from the preprocessed research data as input data of the GIS model; and performing spatial analysis and processing of the research area using the GIS model, extracting river networks, watershed boundaries and hydrologic stations, and carrying out projection transformation and coordinate matching;
Step S13: building and using a digital watershed model to construct and edit the river network topology of the area, extracting each branch of the river network topology, determining positions and attributes of the first starting point and the first ending point of the river network topology, and setting parameters and relationships of the remaining nodes as well as the starting point and the ending point of each branch.

According to one aspect of the present application, the step S2 further comprises:
Step S21: reading the research data, carrying out query and analysis using a pre-configured data management module, dividing time periods, extracting the seawater flow data of each station in chronological order according to spatial positions, and performing statistical analysis and outlier processing;
Step S22: calculating a correlation coefficient or regression equation between the flow of the predetermined station and a saltwater intrusion index by means of correlation analysis or regression analysis, and evaluating the significance and degree of fitting thereof;
Step S23: for each time period, building and verifying a seawater flow spatial-temporal evolution model according to historical seawater flow data and saltwater intrusion index data of each station.

According to one aspect of the present application, the step S3 further comprises:
Step S31: reading the research data, and extracting rainfall data and data of freshwater runoff into the sea of each station in chronological order according to spatial positions;
Step S32: calculating the variation trend or periodicity between the seawater flow and rainfall and freshwater runoff into the sea of each station and the first ending point by means of trend analysis or time series analysis, and evaluating the stability and predictability thereof;
Step S33: based on a hydraulic simulation method, building a freshwater flow spatial-temporal evolution model, and using historical rainfall data and data of freshwater runoff into the sea of each station as training data to predict freshwater flow for future periods.

According to one aspect of the present application, the step S4 further comprises:
Step S41: extracting the current hydrometeorological data and the predicted future hydrometeorological data of the research area in chronological order according to spatial positions, and performing statistical analysis and outlier processing;
Step S42: building a scheduling model for recharging freshwater for repelling saltwater intrusion by a multi-objective optimization method according to an objective function and constraints for recharging freshwater for repelling saltwater intrusion, and solving the objective function based on a pre-configured algorithm to obtain an optimal solution set;
Step S43: for each optimal solution in the optimal solution set, simulating and evaluating the scheduling scheme set using a seawater subsiding model formed by coupling the seawater flow spatial-temporal evolution model and the freshwater flow spatial-temporal evolution model, and choosing an optimal scheme according to comprehensive benefits.

According to one aspect of the present application, the step S21 also comprises:
Step S21a: acquiring the correlation and distance parameters of each station based on the river network topology;
Step S21b: preprocessing the seawater flow data based on the correlation and the distance parameters, wherein the preprocessing comprises statistical analysis and outlier removal;
Step S21c: building and solving a seawater gradient distribution model through the preprocessed seawater flow data.

According to one aspect of the present application, the step S23 also comprises: calculating spatial-temporal evolution of seawater flow based on the seawater flow spatial-temporal evolution model, and performing correction based on the seawater gradient distribution model.

According to one aspect of the present application, in the step S21, the specific process of dividing time periods is as follows: analyzing the annual/dry season variation trends of watershed rainfall and runoff into the sea by means of linear trend analysis or Mann-Kendall rank analysis.

According to the other aspect of the present application, a scheduling system for the operation of reservoirs to recharge freshwater for repelling saltwater intrusion under changing conditions is provided, comprising:
At least one processor; and
A memory communicatively connected with the at least one processor; wherein,

The memory stores instructions that can be executed by the processor, and the instructions are used to be executed by the processor to implement the scheduling method for the operation of reservoirs to recharge freshwater for repelling saltwater intrusion under changing conditions in any one of the above technical solutions.

Beneficial effects: the present invention proposes a threshold value of large flow for ensuring the water supply safety of water sources at the Yangtze Estuary by means of multi-factor correlation analysis; quantifies the effect of operation of the upstream reservoir group on the dry season flow of a station, and clarifies the relationship of response of the flow of a hydrologic station to the change of discharged flow of a reservoir through simulation analysis; and proposes a scheduling scheme for recharging freshwater for repelling saltwater intrusion of reservoirs to estuaries.

### DESCRIPTION OF DRAWINGS

FIG. 1 is a flow chart of the present invention.

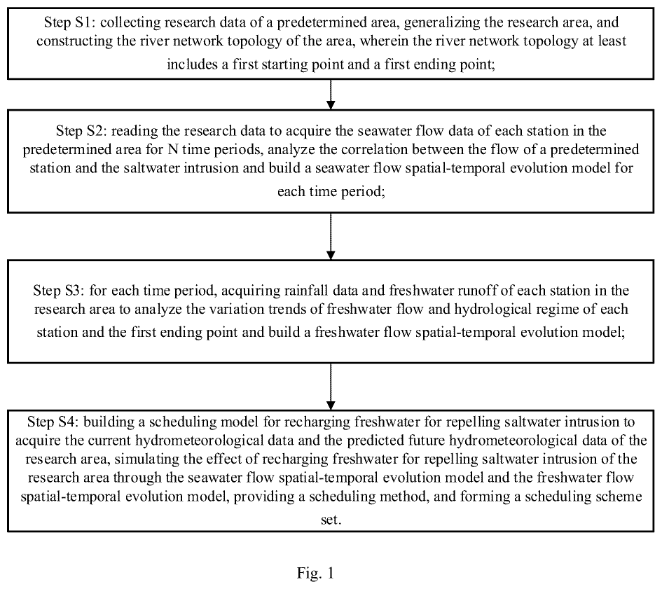

FIG. 2 is a flow chart of step S1 of the present invention.

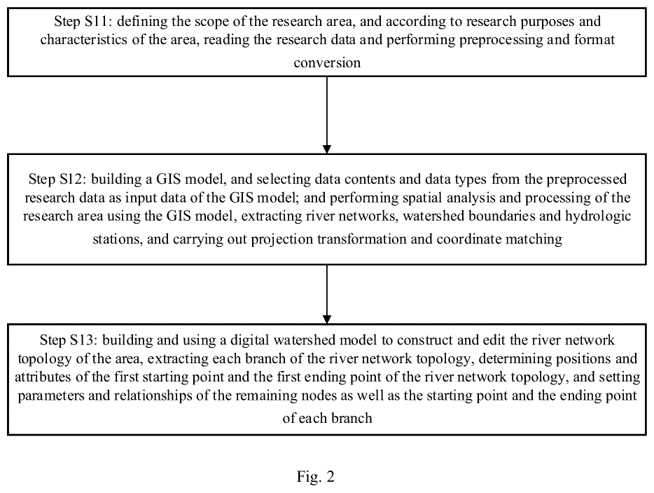

FIG. 3 is a flow chart of step S2 of the present invention.

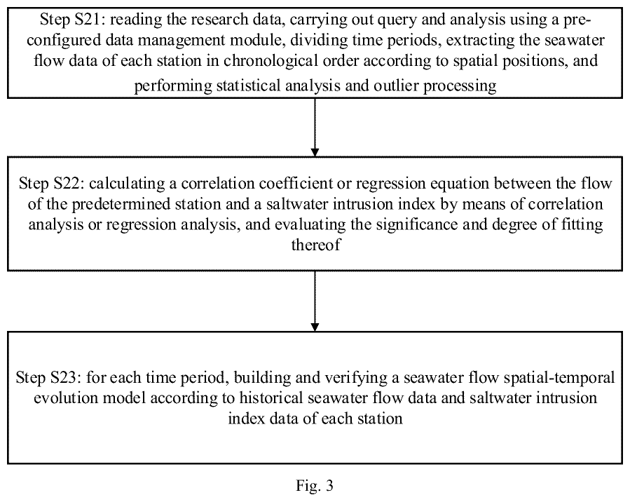

FIG. 4 is a flow chart of step S3 of the present invention.

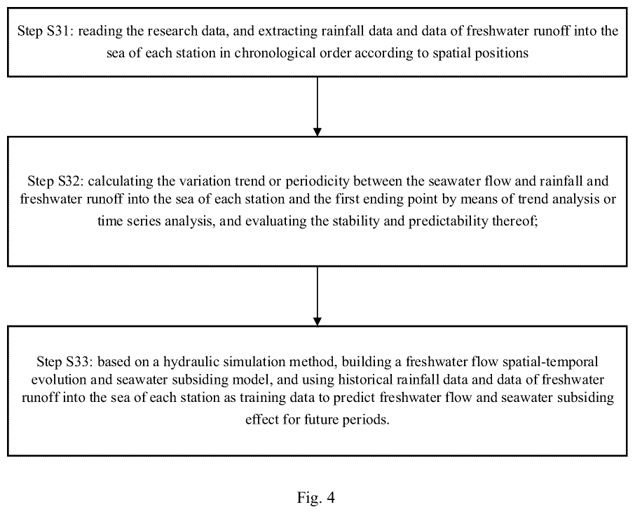

FIG. 5 is an MK analysis chart of annual rainfall of the Yangtze River Basin of the present invention.

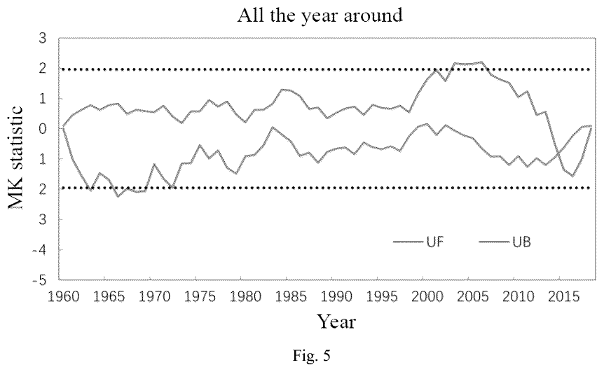

### DETAILED DESCRIPTION

Embodiment 1: a scheduling method for the operation of reservoirs to recharge freshwater for repelling saltwater intrusion under changing conditions is provided, comprising the following steps:
Step S1: collecting research data of a research area, generalizing the research area, and constructing the river network topology of the area, wherein the river network topology at least includes a first starting point and a first ending point, the first starting point is the starting point of freshwater flow, and the first ending point is the ending point of freshwater flow into the sea and the starting point of seawater intrusion flow;
Step S2: reading the research data to acquire the seawater flow data of each station in the research area for N time periods, analyze the correlation between the flow of a predetermined station and the saltwater intrusion and build a seawater flow spatial-temporal evolution model for each time period, wherein N is a positive integer;
Step S3: for each time period, acquiring rainfall data and freshwater runoff of each station in the research area to analyze the variation trends of freshwater flow and hydrological regime of each station and the first ending point and build a freshwater flow spatial-temporal evolution model;
Step S4: building a scheduling model for recharging freshwater for repelling saltwater intrusion to acquire the current hydrometeorological data and the predicted future hydrometeorological data of the research area, simulating the effect of recharging freshwater for repelling saltwater intrusion of the research area through the seawater flow spatial-temporal evolution model and the freshwater flow spatial-temporal evolution model, providing a scheduling method, and forming a scheduling scheme set.

In the present embodiment, the spatial-temporal evolution law of seawater flow is first analyzed through the collected data, and then the spatial-temporal evolution of freshwater flow in the river network is analyzed based on the research data of reservoirs, river network topology and rainfall. On the basis of the above analysis, a scheduling model for recharging freshwater for repelling saltwater intrusion is built according to research purposes, including an objective function and constraints, and then a feasible scheduling scheme is calculated and optimized.

According to one aspect of the present application, the step S1 further comprises:

Step S11: defining the scope of the research area, and according to research purposes and characteristics of the area, reading the research data and performing preprocessing and format conversion. According to the requirements of scope, resolution and time scale of the research area, acquiring the corresponding data types from different data sources, such as satellite images, digital elevation models (DEMs), observed water level flow values and predicted rainfall values; inspecting the quality of the acquired data to eliminate factors affecting data accuracy, such as outliers, missing values and noises; performing format conversion of the data in different formats, for example, converting raster data into vector data or converting image files into text files; and storing the processed data in a uniform format such as shapefile, csv and txt to facilitate subsequent spatial analysis and processing.

For example, acquiring the satellite image data of the basin from the remote sensing center, acquiring the DEM data of the basin from the bureau of surveying and mapping, acquiring the observed water level flow value of the basin from the ministry of water resources, and acquiring the predicted rainfall value of the basin from the meteorological bureau. The data may be in different formats, for example, the satellite image data is in tif format, the DEM data is in asc format, the observed water level flow value is in xls format, and the predicted rainfall value is in txt format. Therefore, after quality inspection, it is necessary to convert the data into a uniform format such as shapefile format or csv format.

Step S12: building a GIS model, and selecting data contents and data types from the preprocessed research data as input data of the GIS model; and performing spatial analysis and processing of the research area using the GIS model, extracting river networks, watershed boundaries and hydrologic stations, and carrying out projection transformation and coordinate matching. The step mainly comprises: importing the data into GIS software such as ArcGIS and QGIS; the data processing procedure can be as follows: extracting river networks and watershed boundaries using DEM, and generating a river attribute table and a basin attribute table; using the position information of the hydrologic stations to create nodes on the river networks, and generating a node attribute table; using projection conversion tools to convert the data of different coordinate systems or projection modes into a uniform coordinate system or projection mode such as WGS84 or UTM; and using coordinate matching tools to align different spatial reference data, for example, registering satellite images with DEM.

Step S13: building and using a digital watershed model to construct and edit the river network topology of the area, extracting each branch of the river network topology, determining positions and attributes of the first starting point and the first ending point of the river network topology, and setting parameters and relationships of the remaining nodes as well as the starting point and the ending point of each branch. Constructing and editing the river network topology based on the river topology data, for example, defining numbers and names of the nodes and branches; using the watershed boundaries to determine the first starting point and the first ending point, and setting the positions and attributes thereof such as reservoir inflow and sea outflow; using the hydrologic stations to set parameters and attributes of other nodes, such as water level, flow and salinity; and using the river attribute table to set parameters and attributes of branches, such as length, width, slope and roughness. Storing the processed data in a uniform format such as inp or prj, and generating a river network topological graph.

According to one aspect of the present application, the step S2 further comprises:
Step S21: reading the research data, carrying out query and analysis using a pre-configured data management module, dividing time periods, extracting the seawater flow data of each station in chronological order according to spatial positions, and performing statistical analysis and outlier processing;
Step S22: calculating a correlation coefficient or regression equation between the flow of the predetermined station and a saltwater intrusion index by means of correlation analysis or regression analysis, and evaluating the significance and degree of fitting thereof. The correlation analysis can be used to calculate a correlation coefficient between the flow of the predetermined station and a saltwater intrusion index (such as salinity and conductivity), and a scatter diagram and a correlation matrix diagram are drawn to evaluate the linear correlation thereof. The regression analysis can also be used to select a suitable regression model (such as linear regression and nonlinear regression) according to the relationship between the flow of the predetermined station and the saltwater intrusion index, and the regression equation and the regression coefficient are solved to evaluate the degree of fitting and significance thereof.

Step S23: for each time period, building and verifying a seawater flow spatial-temporal evolution model according to historical seawater flow data and saltwater intrusion index data of each station.

In a further embodiment, the step S23 can also comprise:
Step S24: building a spatial-temporal topology analysis module, and performing spatial-temporal topology analysis of seawater flow data and saltwater intrusion index data of each station to extract topological characteristics and dynamic evolution laws of spatial-temporal data, wherein the topological characteristics include persistent homology, mapping metric and entropy;

Selecting an appropriate prediction model (comprising a deep neural network and a long short-term memory) according to the topological characteristics and the dynamic evolution laws of the extracted spatial-temporal data, setting parameters (including learning rate and number of iterations), and training and verifying the seawater flow spatial-temporal evolution model for predicting seawater flow for future periods; and using model evaluation tools to evaluate the trained and verified seawater flow spatial-temporal evolution model, calculating the prediction accuracy and reliability of the model, and comparing with other methods (such as linear regression and support vector machine).

According to one aspect of the present application, the step S3 further comprises:

Step S31: reading the research data, and extracting rainfall data and data of freshwater runoff into the sea of each station in chronological order according to spatial positions.

Step S32: calculating the variation trend or periodicity between the seawater flow and rainfall and freshwater runoff into the sea of each station and the first ending point by means of trend analysis or time series analysis, and evaluating the stability and predictability thereof;

Step S33: based on a hydraulic simulation method, building a freshwater flow spatial-temporal evolution model, and using historical rainfall data and data of freshwater runoff into the sea of each station as training data to predict freshwater flow for future periods.

In some embodiments, the step S3 can be executed or analyzed together with the step S2. In this step, the distribution of reservoir inflow and rainfall in the water network can be predicted and evaluated by building the freshwater flow spatial-temporal evolution model, and then a calculation basis is provided for the subsequent process of recharging freshwater for repelling saltwater intrusion.

According to one aspect of the present application, the step S4 further comprises:

Step S41: extracting the current hydrometeorological data and the predicted future hydrometeorological data of the research area in chronological order according to spatial positions, and performing statistical analysis and outlier processing. For example, acquiring hydrometeorological data of the research data, including flow, water level and chlorinity of each estuary and rain forecast for the coming week. Performing statistical analysis using Excel or SPSS software, calculating the average value, standard deviation, maximum value and minimum value of each station, and drawing a line chart and a histogram. Outliers can be detected and eliminated by methods such as box plots or 30 rule.

Step S42: building a scheduling model for recharging freshwater for repelling saltwater intrusion by a multi-objective optimization method according to an objective function and constraints for recharging freshwater for repelling saltwater intrusion, and solving the objective function based on a pre-configured algorithm to obtain an optimal solution set.

The objective function can be min Σ^{N}ᵢ=₁wᵢfᵢ(x), wherein N is the number of objectives, wᵢ is the weight of objectives, fᵢ(x) is an i^{th} objective function, and x is a decision variable; and the objective function mainly includes: effect of repelling saltwater intrusion, water supply safety, ecological protection, shipping guarantee and power benefit. The main constraints are constraints on flow and flow velocity. Reservoir storage shall not exceed the normal water level; reservoir outflow shall not exceed the maximum discharged flow; reservoir inflow shall be equal to the sum of upstream reservoir outflow and runoff along the way; and reservoir outflow shall meet the sum of downstream demand and channel loss. The objective function is solved by a pre-configured algorithm such as genetic algorithm or particle swarm optimization to obtain a set of noninferior solutions, and then an optimal solution set is optimized.

Step S43: for each optimal solution in the optimal solution set, simulating and evaluating the scheduling scheme set using a seawater subsiding model formed by coupling the seawater flow spatial-temporal evolution model and the freshwater flow spatial-temporal evolution model, and choosing an optimal scheme according to comprehensive benefits. Mainly comprising: simulating and evaluating the scheduling scheme set using the seawater flow spatial-temporal evolution model and the freshwater flow spatial-temporal evolution and seawater subsiding model. Scoring each scheme by a comprehensive benefit evaluation method, and choosing the optimal scheme according to the score. The outflow of each reservoir in the optimal scheme is taken as a scheduling instruction and issued to coherent units for execution.

According to one aspect of the present application, the step S21 also comprises:
Step S21a: acquiring the correlation and distance parameters of each station based on the river network topology;

In the present embodiment, the river network topology, including position, attribute and connection relation of each station, can be extracted from the GIS model by the river network topology construction method. According to the river network topology, distance parameters of each station, including length, width, depth and slope of a channel, are calculated.

Step S21b: preprocessing the seawater flow data based on the correlation and the distance parameters, wherein the preprocessing comprises statistical analysis and outlier removal.

In the present embodiment, the seawater flow data is analyzed statistically by means of data preprocessing, for example, calculating the average value, standard deviation, maximum value and minimum value, and drawing a frequency map and a scatter diagram. Outliers such as flow data above or below the normal range are detected and eliminated by methods such as box plots or 3σ rule. According to the correlation and distance parameters of each station, the seawater flow data is interpolated or smoothed to eliminate data discontinuity or noises.

Step S21c: building and solving a seawater gradient distribution model through the preprocessed seawater flow data.

In the present embodiment, a seawater gradient distribution model is built and used to establish and solve a seawater gradient distribution equation according to the preprocessed seawater flow data to obtain the seawater gradient value of each station. Seawater gradient refers to the change rate of seawater flow along the channel direction, which reflects the spatial distribution characteristics of seawater flow. The seawater gradient distribution model can be expressed by the following formula:

∂Q/∂x=−(gAQ|Q|/n²R^{(4/3)}−(gAS₀)/n², wherein Q is seawater flow, x is the coordinate along the channel direction, g is acceleration of gravity, A is the cross-sectional area of the channel, n is the Manning coefficient, R is the hydraulic radius, and S₀ is the bottom slope of the channel.

According to one aspect of the present application, the step S23 also comprises: calculating spatial-temporal evolution of seawater flow based on the seawater flow spatial-temporal evolution model, and performing correction based on the seawater gradient distribution model.

According to one aspect of the present application, in the step S21, the specific process of dividing time periods is as follows: analyzing the annual/dry season variation trends of watershed rainfall and runoff into the sea by means of linear trend analysis or Mann-Kendall rank analysis.

According to one aspect of the present application, the step S4 also comprises forming a fine and intelligent simulation process of recharging freshwater for repelling saltwater intrusion:
Establishing a machine learning input data set based on the research data;
Building a prediction model and an evaluation model for the effect of recharging freshwater for repelling saltwater intrusion, and providing data structure using the corresponding model, including predicting results and evaluation results.

The research data includes hydrometeorological data, topography data, water project data, remote sensing image data and Internet of Things sensor data. The data preprocessing procedure comprises: quality inspection, outlier processing, spatial interpolation and time smoothing, so as to improve data consistency and integrity; the quality inspection refers to the evaluation of data validity, accuracy and integrity; the outlier processing refers to the elimination or correction of data that is beyond the normal range or inconsistent with other data; the spatial interpolation refers to the calculation of data of unknown positions based on data of known positions; and the time smoothing refers to the elimination of noises or filling of missing values based on data of known time.

In one embodiment, the prediction model for the effect of recharging freshwater for repelling saltwater intrusion can select hydrometeorological data, water project data and Internet of Things sensor data as input data. The evaluation model for the effect of recharging freshwater for repelling saltwater intrusion can select remote sensing image data and Internet of Things sensor data as input data.

According to one aspect of the present application, the step S4 also comprises optimizing and adjusting the scheduling schemes in the scheduling scheme set according to actual conditions to adapt to changing factors such as climate change, human activities and water projects inside and outside the research area.

The specific process can be as follows:

Step S4I: acquiring hydrometeorological observation and prediction data, including watershed rainfall, runoff into the sea and seawater tide level; performing statistical analysis using Excel or SPSS software, calculating the average value, standard deviation, maximum value and minimum value of each station, and drawing a line chart and a histogram. Detecting and eliminating outliers by methods such as box plots or 3σ rule. Extracting hydrometeorological observation and prediction data of each station in chronological order according to spatial positions, and performing time series analysis such as trend analysis, period analysis and seasonal analysis. The processed hydrometeorological observation and prediction data is presented on a screen or saved in a file as a table or graph.

Step S4II: acquiring evaluation and planning results of basin water resources, including gross amount, water availability, water demand, water supply and water deficit of basin water resources;

Calculating the average value, standard deviation, maximum value and minimum value of each station, and drawing a line chart and a histogram. Detecting and eliminating outliers by methods such as box plots or 3σ rule. Extracting the evaluation and planning results of basin water resources of each station in chronological order according to spatial positions, and performing comparative analysis such as difference analysis, proportion analysis and change rate analysis. The processed evaluation and planning results of basin water resources are presented on a screen or saved in a file as a table or graph.

Step S4III: analyzing the influence of changing factors inside and outside the basin on the scheduling method and system for recharging freshwater for repelling saltwater intrusion, and performing sensitivity analysis and risk assessment according to different scenarios;

Developing programs for sensitivity analysis and risk assessment, and analyzing the influence of changing factors inside and outside the basin on the scheduling method and system for recharging freshwater for repelling saltwater intrusion, wherein the sensitivity analysis refers to the analysis of the degree to which the output of the scheduling method and system for recharging freshwater for repelling saltwater intrusion responds to changes in input parameters, and the risk assessment refers to the analysis of the probability and severity of adverse consequences that the scheduling method and system for recharging freshwater for repelling saltwater intrusion may have in different scenarios; and according to different scenarios such as drought period, level period and high water period, setting different input parameters such as rainfall, runoff into the sea and seawater tide level, running sensitivity analysis and risk assessment programs to obtain output results of the scheduling method and system for recharging freshwater for repelling saltwater intrusion, for example, effect of repelling saltwater intrusion, water supply safety, ecological protection, shipping guarantee and power benefit, and performing comparative analysis such as sensitivity coefficient analysis, risk level analysis and risk control measure analysis.

Step SIV: dynamically adjusting and optimizing the scheduling scheme for recharging freshwater for repelling saltwater intrusion to balance interests and needs of all parties;

According to the results of sensitivity analysis and risk assessment, determining an objective function and constraints for the scheduling scheme for recharging freshwater for repelling saltwater intrusion, wherein the objective function is a mathematical expression that reflects the comprehensive benefits of the scheduling scheme for recharging freshwater for repelling saltwater intrusion, for example, minimizing water deficit and maximizing power generation, and the constraints refer to the conditions that limit the feasibility of the scheduling scheme for recharging freshwater for repelling saltwater intrusion, for example, reservoir storage shall not exceed the normal water level, and channel flow shall meet the downstream demand;

Running programs for multi-objective optimization and game theory using programming languages such as Matlab or Python to dynamically adjust and optimize the scheduling scheme for recharging freshwater for repelling saltwater intrusion to balance interests and needs of all parties, wherein the multi-objective optimization is to find a solution that makes multiple objective functions reach or approach optimal at the same time on the premise of meeting the constraints, and the game theory refers to the decision theory that studies interaction, competition or cooperation between multiple parties; according to different scenarios such as drought period, level period and high water period, setting different input parameters such as rainfall, runoff into the sea and seawater tide level, and preference or weight of each party such as water department, water supply department, power generation department, shipping department and ecological department; solving a multi-objective optimization problem by methods such as genetic algorithm or particle swarm optimization to obtain a set of noninferior solutions, that is, a set of solutions satisfying multiple objective functions at the same time; and selecting an optimal solution, that is a solution which can balance the interests and needs of all the parties, from the set of noninferior solutions by methods such as Nash Equilibrium or Pareto Optimality. The dynamic adjustment and optimization results of the scheduling scheme for recharging freshwater for repelling saltwater intrusion are presented on a screen or saved in a file as a table or graph.

Embodiment 2: a scheduling method for the operation of reservoirs to recharge freshwater for repelling saltwater intrusion under changing conditions is provided, comprising the following steps:
Step 1: collecting the measured historical runoff data of a runoff into the sea control station and the operational data for scheduling of the upstream reservoir group, analyzing the annual/dry season variation trends of watershed rainfall and runoff into the sea by means of linear trend analysis or Mann-Kendall rank analysis, and selecting a typical low water month which has minimum annual flow and is more prone to saltwater intrusion in history to analyze the variation trend of runoff and the frequency variation of low water runoff;
Step 2: collecting data of water-related projects in a research river reach, and analyzing the influence of the operation of water diversion and drainage projects in dry seasons on the runoff of the Yangtze Estuary based on the actual operational data;
Step 3: according to the measured data and the constructed hydraulic model, statistically analyzing the propagation time of the outflow from the Three Georges Reservoir to the Datong Station, building a multi-objective optimization scheduling model of a reservoir by considering the astronomical tide level, the available water of the reservoir and the propagation time in combination with the analysis results of the correlation between the flow of the runoff into the sea control station and the saltwater intrusion at the estuary, and proposing a reservoir optimization scheduling scheme through multi-objective optimization analysis using an optimization-simulation technology.

According to one aspect of the present application, the annual runoff and dry season runoff composition of the runoff into the sea control station is analyzed to clarify the proportion of inflow above the Three Gorges; based on the operational data of the reservoir, the reservoir has two operational periods: storage period and drought period, the runoff change of the runoff into the sea control station before and after the operation of the reservoir is analyzed, and regression analysis is performed; and based on the existing prediction model for middle and lower reaches of the basin and the constructed hydraulic model for middle and lower reaches of the basin, the relationship of response of change in reservoir discharge to the runoff from the runoff into the sea control station is discussed.

According to one aspect of the present application, the influence factors of saltwater intrusion at the Yangtze Estuary are analyzed based on the statistical data of saltwater intrusion at the Yangtze Estuary over the years, and main influence factors such as average daily flow of the Datong Station, salty tide duration, water quality and tide level are selected to establish a correlation; and the ecological base flow of the Datong Station is analyzed, and the critical flow threshold of the Datong Station is determined according to the requirements of preventing and controlling saltwater intrusion at the Yangtze Estuary and ensuring the water supply safety of water sources.

According to one aspect of the present application, the annual trend change and the dry season trend change of rainfall as well as the trend changes in dry seasons, typical low water months and annual minimum flow of the hydrologic station are analyzed by trend test methods such as linear trend estimation, M-K trend test and wavelet analysis.

According to one aspect of the present application, the step S2 comprises: performing sensitivity analysis of the water inflow of the hydrologic station and the water diversion of the water diversion and drainage projects along the river below the hydrologic station, and selecting the degree of flow reduction of the water diversion and drainage flow below the typical station (Datong Station) as a sensibility index, P=(Q_{typical station}−Q_{water diversion and drainage})/Q_{typical station}*100%.

According to one aspect of the present application, the method also comprises:

Building a downstream hydraulic model, determining river length parameters of generalized river networks and simulated river reaches, setting the hydrodynamic module parameter of the hydraulic model as a roughness coefficient, and setting roughness coefficients respectively for three layers of the section to carry out calibration work.

According to one aspect of the present application, the method also comprises analyzing a saltwater intrusion influence factor, analyzing the average daily flow of the Datong Station and the tidal range of Xuliujing which are common factors affecting chlorinity of water intake (subjected to saltwater intrusion), and determining a correlation between the average daily flow and the tidal range under different durations of saltwater intrusion. It can be found through analysis of the correlation that with the increase of the tidal range under the specific duration of saltwater intrusion, the critical flow required for repelling saltwater intrusion is also increased.

According to one aspect of the present application, a salty tide monitoring network is improved to enhance the salty tide prediction accuracy, the existing monitoring stations are integrated and merged, new stations are established to form a complete salty tide monitoring network covering the whole Yangtze Estuary, and a synchronous monitoring system for chlorinity at the Yangtze Estuary is established preliminarily to strengthen researches on the prediction technology of saltwater intrusion.

According to one aspect of the present application, water supplement for the Three Gorges is started at least about 5 days in advance considering the propagation time in combination with medium-term inflow prediction and salty tide early warning, and if the water supplement duration is 10 days and the water supplement effect is optimal, it is necessary to deploy the scheduling work for water supplement of the Three Gorges about 18-20 days in advance before a salty tide is predicted to arrive.

According to one aspect of the present application, a scheduling system for the operation of reservoirs to recharge freshwater for repelling saltwater intrusion under changing conditions is provided, comprising:
At least one processor; and
A memory communicatively connected with the at least one processor; wherein,

The memory stores instructions that can be executed by the processor, and the instructions are used to be executed by the processor to implement the scheduling method for the operation of reservoirs to recharge freshwater for repelling saltwater intrusion under changing conditions in any one of the above technical solutions.

It should be noted that the specific technical features described in the above specific embodiments may be combined in any suitable manner, provided that there is no contradiction. To avoid unnecessary repetition, various possible combinations are not described separately in the present invention. In addition, various embodiments of the present invention can also be combined arbitrarily, and shall also be regarded as the disclosure of the present invention without departing from the idea of the present invention.

1. A scheduling method for the operation of reservoirs to recharge freshwater for repelling saltwater intrusion under changing conditions, comprising the following steps:
step S1: collecting research data of a research area, generalizing the research area, and constructing the river network topology of the area, wherein the river network topology at least includes a first starting point and a first ending point, the first starting point is the starting point of freshwater flow, and the first ending point is the ending point of freshwater flow into the sea and the starting point of seawater intrusion flow;
step S2: reading the research data to acquire the seawater flow data of each station in the research area for N time periods, analyze the correlation between the flow of a predetermined station and the saltwater intrusion and build a seawater flow spatial-temporal evolution model for each time period, wherein N is a positive integer;
step S3: for each time period, acquiring rainfall data and freshwater runoff of each station in the research area to analyze the variation trends of freshwater flow and hydrological regime of each station and the first ending point and build a freshwater flow spatial-temporal evolution model;
step S4: building a scheduling model for recharging freshwater for repelling saltwater intrusion to acquire the current hydrometeorological data and the predicted future hydrometeorological data of the research area, simulating the effect of recharging freshwater for repelling saltwater intrusion of the research area through the seawater flow spatial-temporal evolution model and the freshwater flow spatial-temporal evolution model, providing a scheduling method, and forming a scheduling scheme set;
the step S2 further comprises:
step S21: reading the research data, carrying out query and analysis using a pre-configured data management module, dividing time periods, extracting the seawater flow data of each station in chronological order according to spatial positions, and performing statistical analysis and outlier processing;
step S22: calculating a correlation coefficient or regression equation between the flow of the predetermined station and a saltwater intrusion index by means of correlation analysis or regression analysis, and evaluating the significance and degree of fitting thereof;
step S23: for each time period, building and verifying a seawater flow spatial-temporal evolution model according to historical seawater flow data and saltwater intrusion index data of each station;
the step S3 further comprises:
step S31: reading the research data, and extracting rainfall data and data of freshwater runoff into the sea of each station in chronological order according to spatial positions;
step S32: calculating the variation trend or periodicity between the seawater flow and rainfall and freshwater runoff into the sea of each station and the first ending point by means of trend analysis or time series analysis, and evaluating the stability and predictability thereof;
step S33: based on a hydraulic simulation method, building a freshwater flow spatial-temporal evolution model, and using historical rainfall data and data of freshwater runoff into the sea of each station as training data;
the step S4 further comprises:
step S41: extracting the current hydrometeorological data and the predicted future hydrometeorological data of the research area in chronological order according to spatial positions, and performing statistical analysis and outlier processing;
step S42: building a scheduling model for recharging freshwater for repelling saltwater intrusion by a multi-objective optimization method according to an objective function and constraints for recharging freshwater for repelling saltwater intrusion, and solving the objective function based on a pre-configured algorithm to obtain an optimal solution set;
step S43: for each optimal solution in the optimal solution set, simulating and evaluating the scheduling scheme set using a seawater subsiding model formed by coupling the seawater flow spatial-temporal evolution model and the freshwater flow spatial-temporal evolution model, and choosing an optimal scheme according to comprehensive benefits.

2. The scheduling method for the operation of reservoirs to recharge freshwater for repelling saltwater intrusion under changing conditions according to claim 1, wherein the step S1 further comprises:
step S11: defining the scope of the research area, and according to research purposes and characteristics of the area, reading the research data and performing preprocessing and format conversion;
step S12: building a GIS model, and selecting data contents and data types from the preprocessed research data as input data of the GIS model; and performing spatial analysis and processing of the research area using the GIS model, extracting river networks, watershed boundaries and hydrologic stations, and carrying out projection transformation and coordinate matching;
step S13: building and using a digital watershed model to construct and edit the river network topology of the area, extracting each branch of the river network topology, determining positions and attributes of the first starting point and the first ending point of the river network topology, and setting parameters and relationships of the remaining nodes as well as the starting point and the ending point of each branch.

3. The scheduling method for the operation of reservoirs to recharge freshwater for repelling saltwater intrusion under changing conditions according to claim 2, wherein the step S21 also comprises:
step S21a: acquiring the correlation and distance parameters of each station based on the river network topology;
step S21b: preprocessing the seawater flow data based on the correlation and the distance parameters, wherein the preprocessing comprises statistical analysis and outlier removal;
step S21c: building and solving a seawater gradient distribution model through the preprocessed seawater flow data.

4. The scheduling method for the operation of reservoirs to recharge freshwater for repelling saltwater intrusion under changing conditions according to claim 3, wherein the step S23 also comprises: calculating spatial-temporal evolution of seawater flow based on the seawater flow spatial-temporal evolution model, and performing correction based on the seawater gradient distribution model.

5. The scheduling method for the operation of reservoirs to recharge freshwater for repelling saltwater intrusion under changing conditions according to claim 4, wherein in the step S21, the specific process of dividing time periods is as follows: analyzing the annual/dry season variation trends of watershed rainfall and runoff into the sea by means of linear trend analysis or Mann-Kendall rank analysis.

6. A scheduling system for the operation of reservoirs to recharge freshwater for repelling saltwater intrusion under changing conditions, comprising:
at least one processor; and
a memory communicatively connected with the at least one processor; wherein,
the memory stores instructions that can be executed by the processor, and the instructions are used to be executed by the processor to implement the scheduling method for the operation of reservoirs to recharge freshwater for repelling saltwater intrusion under changing conditions in claim 1.
